(19) United States
(12) Patent Application Publication
(10) Pub. No.: US 2010/0304099 A1
(43) Pub. Date: Dec. 2, 2010

(54) Adherent Fabric Articles and Associated Methods

(76) Inventors: David Osborne, Cedar Hills, UT (US); Darren Jones, American Fork, UT (US)

Correspondence Address: David Osborne, 9638 Dorchester Dr., Cedar Hills, UT, 84062, US

(21) Appl. No.: 12/790,643

(22) Filed: May 28, 2010

Related U.S. Application Data
(60) Provisional application No. 61/183,329, filed on Jun. 2, 2009.
(60) Provisional application No. 61/293,570, filed on Jan. 8, 2010.

(51) Int. Cl. B32B 3/10; B32B 5/02

(52) U.S. Cl. 428/196; 428/221

(57) ABSTRACT

Adherent fabric articles and uses therefor are disclosed and described. In one aspect, an adherent fabric article may include a fabric layer bonded to a cling layer. In use, the fabric layer can be used to clean, polish, or treat a surface of a device, such as a scratch sensitive surface. Once cleaning, polishing, or treating is complete, the adherent fabric article can be stored on the device by adhering it to a smooth surface on the device using the cling layer. Moreover, in this position, the article may be used to protect the surface of the device to which the article is adhered. Further, the fabric portion of the article may be imaged to allow the article to be decorative in nature when adorning a device, or to provide messaging or advertisement.

### PRIORITY DATA

This application claims the benefit of U.S. Provisional Patent Application Ser. Nos. 61/183,329 and 61/293,570, filed Jun. 2, 2009 and Jan. 8, 2010 respectively, each of which is incorporated herein by reference in its entirety.

### FIELD OF THE INVENTION

The present invention relates generally to articles, systems, and methods of removably adhering a fabric layer to a surface. As such, the present invention involves the field of material sciences.

### BACKGROUND OF THE INVENTION

Many consumer and industrial devices have exposed surfaces which benefit from routine cleaning or polishing. Often devices can be scratch sensitive, such as electronics, musical instruments, devices with a lacquered or varnished finish, devices with a polished metal finish, and devices with a glass or transparent polymer finish surface. One example of such a device may be a hand held gaming device with a transparent view screen. Another example may be a guitar with a clear coat lacquer finish. Yet another example may be a trumpet. A further example may be eyewear including sunglasses, ski goggles, etc. Yet another example may be an optically readable disk, such as a CD, DVD, or other polycarbonate disk.

A variety of fabrics have become know for performing cleaning and polishing tasks, including cleaning and polishing of scratch sensitive surfaces. Cotton fabrics, soft wool fabrics, and many synthetic fiber woven fabrics and felted fabrics are known. One particular type of fabric which has become popular for its use on scratch sensitive surfaces is known as “micro fiber”. Microfiber textiles are woven or non-woven products made of fibers with typically less than 1 dernier per filament. Fibers are combined to create yarns and yarns are knitted or woven into a variety of constructions and textile products or fabrics. The ultra small fiber size and tight construction of many microfiber textiles impart to the fabric exceptional softness along with super absorbance of water and oils, as well as capture of dirt.

While use of fabrics in cleaning or polishing various devices is desirable, the storage and association of the fabric with the target device can be inconvenient. This is especially true with portable devices having smooth surfaces which provide little purchase opportunity because of a lack of cavities, protrusions, etc. One example of such device is a typical laptop or notebook computer. Most of such devices present a boxy form factor with a mostly smooth exterior surface affording little to no purchase opportunity for tying, affixing, appending, or otherwise storing a fabric sheet. As such, the fabric must be carried on an individual, such as in a pocket, or otherwise stored away from the device of intended use.

### SUMMARY OF THE INVENTION

It has been recognized by the present inventors that there is a need for fabric products that can be used to clean or polish devices with scratch sensitive surfaces and that can be stored on the device in locations that typically offer little or no purchase opportunity. It has also been recognized that such devices should be as simply constructed (i.e. with the fewest number of required pieces), be as thin and flexible as possible, and be inexpensively prepared. Accordingly, the present invention provides composite fabric articles and associated methods for the use and fabrication thereof.

In one aspect, such a composite fabric article may include a fabric layer having a working surface suitable for cleaning or polishing a scratch sensitive surface, and a cling layer having a cling surface suitable for adhering to a smooth surface. The fabric layer and cling layer are typically bonded to one another such that the working surface and cling surface are on opposing sides of the article.

In another aspect, the present invention encompasses a two layer composite fabric article. The article may consist essentially of a fabric layer and a cling layer permanently bonded together by an adhesive. In such case, the fabric layer typically has a working surface suitable for cleaning or polishing a scratch sensitive surface, and the cling layer typically has a cling surface suitable for adhering to a smooth surface. The fabric layer and cling layer are bonded to one another such that the working surface and cling surface are on opposing sides of the article.

The present invention further encompasses methods for protecting a smooth scratch sensitive surface on a device. In one embodiment, such a method may include the steps of providing an article as recited herein, and adhering the cling surface of the cling layer of the article along at least a portion of the smooth scratch sensitive surface.

Methods for cleaning, polishing, or treating a device are additionally included in the present invention. In one aspect, such a method can include providing a device as recited herein, and actuating the working surface of the fabric layer against a surface of the device in a manner sufficient to clean, polish, or treat the device.

In yet another aspect of the invention, methods of decorating a device are included. Such a method may for example, include providing an article as recited herein having a fabric layer that is imaged with an image, and adhering the cling surface of the cling layer of the article along at least a portion of a smooth surface on the device.

The present invention additional extends to methods of displaying information on a device. In some embodiments, such a method may include providing at least one article as recited herein having a fabric layer that is imaged with an image, and adhering the cling surface of the cling layer of the article along at least a portion of a smooth surface on the device.

In yet an additional aspect, the present invention encompasses methods of making a composite fabric article having a fabric layer adhesively bonded to a cling layer. Such a method may include assembling a microfiber fabric layer and a vinyl cling layer with an adhesive therebetween, pressing the assembly in a heat press at a temperature of from about 140° F. to about 250° F., at a pressure of from about 40 to about 100 psi, for a time of from about 3 to about 30 seconds, and removing the article from the heat press. In some aspects, the heat press may be a sublimation heat press and an image on the fabric layer may be simultaneously created with the article. In other aspects, the imaging of the fabric may be previously performed.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a cross sectional view of a composite adherent fabric article with one embodiment of the present invention.

FIG. 2 is a top view of multiple articles in accordance with the present invention that have been imaged on the fabric layer and adhered to a substrate in a manner that conveys a message in accordance with one embodiment of the present invention.

### DETAILED DESCRIPTION OF THE INVENTION

### Definitions

In describing and claiming the present invention, the following terminology will be used in accordance with the definitions set forth below.

The singular forms “a,” “an,” and, “the” include plural referents unless the context clearly dictates otherwise. Thus, for example, reference to “a layer” includes reference to one or more of such layers, and reference to “an adhesive” includes reference to one or more of such adhesives.

As used herein, “fabric” refers to any type of woven, non-woven, or fibrous layer of material that is suitable for use in cleaning scratch sensitive surface of a device without causing any substantial damage thereto. One example of a suitable fabric is a polyester or a polyamide microfiber fabric.

As used herein, “working surface” refers to a surface of a device that is oriented toward an object upon which work is performed, during the work process. As one example, a working surface of a fabric layer used to clean or treat the lacquered surface of a guitar would be the surface of the fabric layer which is oriented toward the guitar and contacts the guitar during the act of cleaning or treating.

As used herein, “cling surface” refers to a surface of a cling layer which contacts an object to which the cling layer clings or adheres without the using any additional adhesive mechanism other than the properties of the cling layer itself, and to which the cling layer is only temporarily affixed or adhered. As an example, a cling surface of a cling layer used to adhere or affix the cling layer to a transparent lap top screen is that surface which contacts the screen and clings or adheres to it through whatever forces or properties provided by the cling surface. Examples of such cling properties include without limitation, adhesive forces, frictional forces, electrostatic forces, ionic forces, suction forces, surface area contact, van der waals forces, etc.

As used herein, “suitable for,” “sufficient to,” “adequate for,” and other indicators of qualified function, refer to the ability of a named member, structure, or material, to perform an intended or stated function without substantially undermining the functionality, performance, or integrity of a separate, but involved, member, structure, or material. By way of example without limitation, “suitable for cleaning” when used in connection with a fabric, refers to the ability of the fabric to remove undesirable materials from a scratch sensitive transparent layer without substantially damaging or diminishing the transparency of the transparent layer. In some aspects, such cleaning may include restoring or improving a transparent quality or property to an originally transparent material or layer. In addition, “suitable for adhering” when used in connection with a cling layer, refers to the ability of the cling layer to be adhered to, and then subsequently removed from, a scratch sensitive transparent surface without substantially diminishing or reducing the transparency of the transparent surface.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

### The Invention

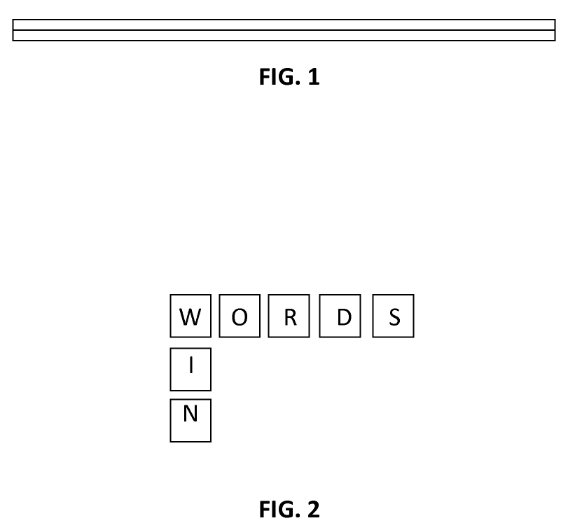

The present invention provides composite fabric articles and associated methods and systems for the use and manufacture thereof. Referring now to FIG. 1 is shown a composite fiber article 10 in accordance with one aspect of the present invention. The article 10 has a fabric layer 20 and a cling layer 30. The fabric layer has a working surface 40 and the cling surface has a cling surface 50. The fabric and cling layers are bonded together along facing portions 60 to create a composite article with the working surface 40 of fabric layer 20 and the cling surface 50 of the cling layer 30 on, or forming, opposing sides of the composite fabric article 10. In some embodiments, the article will have a size and shape sufficient to adhere to various surfaces of various devices.

The article of the present invention may take a variety of specific shapes and sizes. In one embodiment, the article may square, circular, oval, triangular, asymmetrical, oblong, rectangular, or nearly any other desired geometric configuration. In one aspect, the article may have a shape that substantially matches that of an optically readable disk such as a CD or a DVD. In another aspect, the shape may substantially match that of the back of a cell phone. In yet another aspect, the shape may substantially match the back of, or a portion of the back of a hand held electronic device. In yet a further aspect, the shape may substantially match that of a portion of a musical instrument. In another aspect, the shape may substantially match that of a transparent screen of an electronic device, such as a hand held gaming device, cell phone, tablet computing device, laptop computer, etc. Moreover, multiple matching articles with complimentary shapes may be used in order to cover a desired surface on a device.

In some aspects of the invention, the fabric layer and the cling layer may be of substantially matching shapes and sizes and share a common perimeter edge. In other aspects, they may be different. In some aspects, the cling layer may be smaller than the fabric layer. Also, multiple cling layers or a segmented or sectional cling layer may be used across the fabric. In one aspect, the cling layer may comprise or consist essentially of small segments or dots adhered to one side of the fabric layer. Such configurations may allow the composite fabric article to sufficiently adhere to a desired surface on a device, while using minimal amounts of cling material, thus providing additional flexibility to the fabric layer.

The composite fabric article of the present invention may utilize materials that provide the article with a desired overall thickness. In some aspects very thin materials may be used in order to maximize flexibility and minimize article profile when adhered to a device surface. In other aspects, a thicker profile that is sufficient to cushion and protect a device surface to which the article is adhered may be used. One example of a thinner profile may be an article intended for adherence to the back of a hand held electronic device that will be repeatedly inserted and removed from a user's pocket. In such cases a minimal profile may be desired to minimize the incidents of snagging on the pocket. By contract, in another aspect, the composite fabric article may be adhered to the back of a guitar as a rash guard to prevent or minimize marring or scratching of the back of the guitar by a user's belt buckle or other durable device against which the guitar back may come. In such cases, the thickness of the composite fabric article may be adjusted to as to be sufficiently thick as to provide a substantial cushioning and protective effect while still allowing the article to be flexible and effectively used in the capacity of cleaning, polishing, or treating the guitar, or other devices.

Referring again to FIG. 1, the fabric layer 20 and the cling layer 30 may be bonded together using a suitable adhesive material, such as a fabric adhesive, or other contact adhesive. Nearly any polymeric adhesive material or bonding agent that is suitable for permanently securing the fabric layer 20 and the cling layer 30 to one another, and which allow the overall device sufficient flexibility to adequately function in cleaning, treating, polishing, and/or protecting the surface of a device can be used. Curable adhesives and polymers that are cured by pressure, heat, or UV light can be used, for example. In one aspect, the adhesive may be a polyethylene adhesive.

The form of the adhesive can also vary as required to accommodate an overall fabrication process for the article. In some aspects the adhesive may be applied in a liquid form, including via a spray. In other aspects, the adhesive may be applied in a solid form, such as a web or woven fabric, or other sheet of adhesive fibers or adhesive film, which then liquefies and congeals during processing.

In some aspects the bonding agent or adhesive may be substantially the only material between the fabric and cling layers. In this case, the present device may consist essentially of a fabric layer, a cling layer, and an adhesive there between, which bonds the fabric and cling layers together. In another aspect, multiple adhesives, or adhesive layers, or other members can be used.

In another aspect of the present invention, the fabric layer 20 and the cling layer may be bonded directly together by a heat treatment, a mechanical or physical interaction, or other bonding mechanism based on the nature of the fabric and cling materials selected and used. In this case, application of a separate intermediate material, such as an adhesive or bonding agent used to bond the layers together may be avoided. Again, such a device must retain sufficient flexibility and pliability so as to be able to function in caring adhering to and caring for device as described herein. In such embodiments, the device may consist essentially of a fabric layer and a cling layer.

A variety of materials can be used for the fabric layer 20 which are suitable for performing the cleaning and polishing functions desired of the fabric layer. Microfibers, both woven and unwoven may be used. Specific weave tightness and fabric weight may also be selected as required in order to produce a product with desired cleaning and polishing characteristics. In one embodiment, the microfiber may be a polyester microfiber that is either woven or unwoven. In another aspect the microfiber may be a polyamide micro fiber, either woven or unwoven. In yet a further aspect, the microfiber may be a conjugated polyester and polyamide microfiber that is either woven or unwoven. Other cloth materials such as cotton and synthetic materials such as nylon can also be used, again with the proviso that they be suitable for cleaning or polishing a scratch sensitive device to which the article is adhered.

Likewise, a variety of cling materials may be used for the cling layer 30 which will suitably adhere to a smooth surface of various devices. Examples of such materials include polymeric materials and gel materials. In one aspect, the cling material may be a material that adheres to smooth surfaces, such as the read side of a data disk, but does not substantially adhere to a roughened surface. In another aspect, the polymeric material may be a vinyl material, such as a vinyl polymer that provides a static cling force sufficient to adhere to a smooth surface such as glass or other device smooth surface. In another aspect, a gel material may be used which contains numerous bubbles and cavities which provide a suction effect to aid in adhesion. In yet another aspect, the cling layer may be any other type of adhesive film or layer, with or without bubbles, such as a pressure sensitive adhesive, that is capable of adhering the composite fabric article to the smooth scratch sensitive surface of a device and then removing the article without leaving a substantial adhesive residue on the device.

Overall, the bonding of the cling material to the fabric layer generally alters many physical properties of the fabric layer. Fabric layers by their nature are typically able to bunch and gather freely and have a free form to their movement which is valuable for purposes of handling and engaging in cleaning and polishing actions. For example, when cleaning a surface, a fabric may be bunched in a users hand for the purpose of gaining sufficient purchase on the fabric to be able to actuate it across the surface of the item being cleaned or polished. Further, such bunching or gathering also creates multiple folds in the fabric which are able to act as pressure points to further aid in removing material off of the surface being cleaned, and to hide the removed material within the folds of the fabric to allow a lengthened cleaning period. By contrast, many cling materials which are highly polymeric do not have the bunching and gathering capacity of a fiber layer, but rather are resilient and tend to hold a flat shape when formed into a layer. As a result, many polymeric cling materials effectively overcome a fabric's natural movement properties when bonded to the fabric, and force the fabric to take on the movement and physical properties of the polymeric cling material. As a result, in some aspects of the present invention, the selection of a cling material may be made, including both specific material, thickness, and uninterrupted surface area, which allows the fabric to maintain as many of its natural physical properties and movement behavior as possible.

In addition to the composite fabric articles and systems recited herein, the present invention encompasses methods of protecting, cleaning, polishing, treating, or otherwise caring for a device with scratch sensitive surface. Such methods generally may include providing a composite fabric article as recited herein, and adhering the article to a smooth surface of the device. When cleaning, polishing, or treating is required, the device is removed, oriented with the fabric side toward the device and then contacted or actuated against the device. The article can then be replaced on the smooth surface using the cling layer after use of the article is complete. It is to be understood that the above-recited steps are not in a required order.

Turning now to FIG. 2 is shown a top view of a plurality of composite fabric articles in accordance with the present invention. As can be seen, the articles have been imaged on the fabric layer with letters to form words. The articles are further adhered to a device. In this manner, messages and advertising may be delivered using the articles of the present invention. A single article alone may be used for this purpose, or a plurality of articles may work together to convey a message as shown in FIG. 2. Letters, words, symbols, drawings, images, figures, or other markings may be imaged on the working surface of the fabric layer so as to convey information as desired. Further, the underside of the fabric layer may be similarly imaged. In this circumstance, the image will be visible through the cling layer when a clear or transparent cling layer and adhesive is used.

In some aspects, the information displayed may be singular, such as an idea or concept. In other aspects the information may be linear, such as a phrase, sentence, or music. In yet another aspect, the information may be music, such as notes or cords assembled in a specific order sufficient to create a song or song fragment.

The following examples present various methods for making the coated superabrasive particles and tools of the present invention. Such examples are illustrative only, and no limitation on present invention is meant thereby.

### EXAMPLES

### Example 1

A woven and brushed layer of approximately 190 gram polyester or polyamide microfiber is provided. The microfiber layer can optionally be dye sublimated on one or both sides with an image or text. A layer of 7.5 mil static cling vinyl is also provided. The vinyl can be clear or colored. A polyethylene woven adhesive is placed between the microfiber and the vinyl layers. The assembled layers are then pressed together using a heated flatbed press (or alternatively rollers) at a temperature of about 210° F. to about 250° F. and a pressure of about 60 to about 80 PSI for a period of about 20 to about 30 seconds. Once the adhesive is cured, and the layers have cooled, a die cut stamp machine is used to cut the layers into a desired shape for the devices of the present invention.

### Example 2

The same as Example 1, except that the temperature of the press is a temperature of about 170° F. to about 240° F. and the pressure is from about 50 to about 90 pounds of pressure for a period of about 4 to about 9 seconds.

### Example 3

The same as Examples 1 or 2, except a sublimation image is formed on the working side of the microfiber fabric simultaneously with the formation of the composite fabric article. The sublimation template containing the dyed image is aligned with the working surface of the fabric layer and pressing and heating of the assembly occurs as described herein.

### LIST OF SPECIFIC EMBODIMENTS

1. A composite fabric article comprising:

a fabric layer having a working surface suitable for cleaning or polishing a scratch sensitive surface; and

a cling layer having a cling surface suitable for adhering to a smooth surface, said fabric layer and said cling layer being bonded to one another such that the working surface and cling surface are on opposing sides of the article.

2. The article of embodiment 1, wherein the fabric layer and the cling layer substantially match in shape and have a common continuous perimeter edge.
3. The article of embodiment 1, wherein the fabric layer and cling layer are bonded by an adhesive material.
4. The article of embodiment 1, wherein the adhesive material is substantially the only material between the fabric layer and the cling layer.
5. The article of embodiment 1, wherein the fabric layer and cling layer are bonded directly together without any intermediate material.
6. The article of embodiment 1, fabric layer is a microfiber material.
7. The article of embodiment 6, wherein the microfiber material is a polyester microfiber.
8. The article of embodiment 7, wherein the microfiber material is a polyamide microfiber.
9. The article of embodiment 6, wherein the microfiber material is a conjugate of polyester and polyamide.
10. The article of embodiment 1, wherein the cling material is a polymeric material.
11. The article of embodiment 10, wherein the polymeric material is a static cling material.
12. The article of embodiment 11, wherein the static cling material is either a vinyl or a polyester or a mixture or copolymer thereof.
13. The article of embodiment 10, wherein the polymeric material includes entrapped bubbles which aid in cling.
14. The article of embodiment 1, wherein the cling material is a gel.
15. The article of embodiment 1, wherein the cling material selected allows the fabric layer to substantially retain a majority of its physical properties.
16. The article of embodiment 1, wherein the fabric layer is imaged with an image.
17. The article of embodiment 16, wherein the image includes a color, letters, a design, a pattern, a picture, a map, a message, or a combination thereof.
18. The article of embodiment 16, wherein the image is an advertisement.
19. The article of embodiment 16, wherein the image is a single unit in a group of multiple articles which collectively convey information when utilized together.
20. A method of protecting a smooth scratch sensitive surface on a device comprising:

providing an article as recited in embodiment 1; and

adhering the cling surface of the cling layer of the article along at least a portion of the smooth scratch sensitive surface.

21. A method of cleaning, polishing, or treating a device comprising:

providing a device as recited in embodiment 1; and

actuating the working surface of the fabric layer against a surface of the device in a manner sufficient to clean, polish, or treat the device.

22. A method of decorating a device comprising:

providing an article as recited in embodiment 16; and

adhering the cling surface of the cling layer of the article along at least a portion of a smooth surface on the device.

23. A method of displaying information on a device comprising:

providing at least one article as recited in embodiment 16; and

adhering the cling surface of the cling layer of the article along at least a portion of a smooth surface on the device.

24. The method of embodiment 23, further comprising adhering multiple articles to the device in a sequence that displays linear information.
25. The method of embodiment 24, wherein the linear information is letters or words forming a message.
26. The method of embodiment 24, wherein the linear information is a sequence of images or scenes.
27. The method of either of embodiments 25 or 26, wherein the device is a gaming board.
28. The method of embodiment 24, wherein the linear information is music.
29. The method of embodiment 28, wherein the device is a musical instrument.
30. The method of embodiment 22, wherein the device is an electronic device.
31. A two layer composite fabric article consisting essentially of:

a fabric layer having a working surface suitable for cleaning or polishing a scratch sensitive surface; and

a cling layer having a cling surface suitable for adhering to a smooth surface, said fabric layer and said cling layer being bonded to one another such that the working surface and cling surface are on opposing sides of the article;

said fabric layer and said cling layer being permanently bonded together by an adhesive.

32. The article of embodiment 31, wherein the fabric layer is one of: a woven or non-woven polyester microfiber, a woven or non-woven polyamide microfiber, or a woven or non-woven polyester and polyamide conjugated microfiber.
33. The article of embodiment 32, wherein the microfiber is a woven polyamide microfiber
34. The article of embodiment 31, wherein the cling layer is a vinyl cling layer.
35. The article of embodiment 34, wherein the adhesive is a polyethylene containing adhesive.
36. A method of making a composite fabric article having a fabric layer adhesively bonded to a cling layer comprising:

assembling a microfiber fabric layer and a vinyl cling layer with an adhesive therebetween;

pressing the assembly in a heat press at a temperature of from about 210° F. to about 250° F., at a pressure of from about 60 to about 80 psi, for a time of from about 20 to about 30 seconds; and

removing the article from the heat press.

37. The method of embodiment 36, wherein the microfiber fabric layer is a polyamide microfiber and the adhesive is a polyethylene adhesive.
38. The method of embodiment 36, wherein adhesive is provided as a distributed liquid.
39. The method of embodiment 36, wherein the adhesive is provided as a solid sheet.
40. The method of embodiment 36, wherein the adhesive is provided as a woven sheet.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A composite fabric article comprising:
a fabric layer having a working surface suitable for cleaning or polishing a scratch sensitive surface; and
a cling layer having a cling surface suitable for adhering to a smooth surface, said fabric layer and said cling layer being bonded to one another such that the working surface and cling surface are on opposing sides of the article.

2. The article of claim 1, wherein the fabric layer and the cling layer substantially match in shape and have a common continuous perimeter edge.

3. The article of claim 1, wherein the fabric layer and cling layer are bonded by an adhesive material.

4. The article of claim 1, wherein the adhesive material is substantially the only material between the fabric layer and the cling layer.

5. The article of claim 1, wherein the fabric layer and cling layer are bonded directly together without any intermediate material.

6. The article of claim 1, fabric layer is a microfiber material.

7. The article of claim 6, wherein the microfiber material is a polyester microfiber.

8. The article of claim 7, wherein the microfiber material is a polyamide microfiber.

9. The article of claim 6, wherein the microfiber material is a conjugate of polyester and polyamide.

10. The article of claim 1, wherein the cling material is a polymeric material.

11. The article of claim 10, wherein the polymeric material is a static cling material.

12. The article of claim 11, wherein the static cling material is either a vinyl or a polyester or a mixture or copolymer thereof.

13. The article of claim 10, wherein the polymeric material includes entrapped bubbles which aid in cling.

14. The article of claim 1, wherein the cling material is a gel.

15. The article of claim 1, wherein the cling material selected allows the fabric layer to substantially retain a majority of its physical properties.

16. The article of claim 1, wherein the fabric layer is imaged with an image.

17. The article of claim 16, wherein the image includes a color, letters, a design, a pattern, a picture, a map, a message, or a combination thereof.

18. The article of claim 16, wherein the image is an advertisement.

19. The article of claim 16, wherein the image is a single unit in a group of multiple articles which collectively convey information when utilized together.

20. A two layer composite fabric article consisting essentially of:
a fabric layer having a working surface suitable for cleaning or polishing a scratch sensitive surface; and
a cling layer having a cling surface suitable for adhering to a smooth surface, said fabric layer and said cling layer being bonded to one another such that the working surface and cling surface are on opposing sides of the article;
said fabric layer and said cling layer being permanently bonded together by an adhesive.
